(19) United States
(12) Patent Application Publication
(10) Pub. No.: US 2007/0239457 A1
(43) Pub. Date: Oct. 11, 2007

(54) Method, apparatus, mobile terminal and computer program product for utilizing speaker recognition in content management

(75) Inventors: Antti Sorvari, Itasalmi (FI); Tomi Myllyla, Espoo (FI); Joonas Paalasmaa, Helsinki (FI); David Murphy, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/401,201

(22) Filed: Apr. 10, 2006

(51) Int. Cl. G10L 21/00

(52) U.S. Cl. 704/270

(57) ABSTRACT

An apparatus for utilizing speaker recognition in content management includes an identity determining module. The identity determining module is configured to compare an audio sample which was obtained at a time corresponding to creation of a content item to stored voice models and to determine an identity of a speaker based on the comparison. The identity determining module is further configured to assign a tag to the content item based on the identity.

### FIELD OF THE INVENTION

Embodiments of the present invention relate generally to content management technology and, more particularly, relate to a method, apparatus, mobile terminal and computer program product for utilizing speaker recognition in content management.

### BACKGROUND OF THE INVENTION

The modem communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the storage capacity of such devices has allowed users to store very large amounts of content on the devices. Given that the devices will tend to increase in their capacity to store content, and given also that mobile electronic devices such as mobile phones often face limitations in display size, text input speed, and physical embodiments of user interfaces (UI), challenges are created in content management. Specifically, an imbalance between the development of stored content capabilities and the development of physical UI capabilities may be perceived.

In order to provide a solution for the imbalance described above, context metadata has been utilized to enhance content management. Context metadata includes information that describes the context in which a particular content item was “created”. Hereinafter, the term “created” should be understood to be defined such as to encompass also the terms captured, received, and downloaded. In other words, content is defined as “created” whenever the content first becomes resident in the device, by whatever means regardless of whether the content previously existed on other devices. Context metadata can be associated with each content item in order to provide an annotation to facilitate efficient content management features such as searching and organization features. Accordingly, the context metadata may be used to provide an automated mechanism by which content management may be enhanced and user efforts may be minimized.

One type of context metadata is information regarding which people were in proximity to the user when a certain content item was created. Metadata pertaining to which people are associated with a content item may be used to search or organize content items. Thus, the content items and associated metadata may be transferred to other devices, such as storage devices, personal computers, video recorders, remote servers, etc. to enhance content management in these devices as well. An exemplary method of detecting people in proximity when a certain content item was created is based on detecting nearby electronic devices such as mobile phones, which may then be associated with their corresponding owners. For example, a scan of the environment proximate to the user of a mobile terminal may detect the presence of other Bluetooth, WLAN, WiMax, or UWB devices. This method has been described, for example, by Sorvari et al.: “Usability issues in utilizing context metadata in content management of mobile devices.” NordiCHI '04: Proceedings of the third Nordic conference on Human-computer interaction, ACM Press: 357-363. However, it is not always possible to identify nearby devices since many such devices may be configured to prevent such identification.

Thus, it may be advantageous to provide other methods of associating context metadata with individuals close to the user when a content item is created, which do not depend on the configuration or the capabilities of a nearby device.

### BRIEF SUMMARY OF THE INVENTION

A method, apparatus, mobile terminal and computer program product are therefore provided that utilize speaker recognition in metadata-based content management. Accordingly, when a content item is created, a recording of the voice of a nearby speaker (or speakers) may be used to assign context metadata associated with an identity of the speaker (or speakers). The identity of the speaker may be associated with a characterization of the speaker such as, for example, a name (if known), a device or phonebook entry associated with the speaker, a manually created label, or a recognized face. In this regard, a voice model of each of a plurality of known or unknown speakers may be compared to the recording to determine the identity of the speaker. Thus, the context metadata may be used to enhance content management of content items based on the identity of the speaker.

In one exemplary embodiment, methods and computer program products for utilizing speaker recognition in metadata-based content management are provided. The methods and computer program products include first, second and third operations or executable portions. The first operation or executable portion is for comparing an audio sample which was obtained at a time corresponding to creation of a content item to stored voice models. The second operation or executable portion is for determining an identity of a speaker based on the comparison. The third operation or executable portion is for assigning a tag, such as metadata, to the content item based on the identity.

In another exemplary embodiment, an apparatus for utilizing speaker recognition in content management is provided. The apparatus includes an identity determining module. The identity determining module is configured to compare an audio sample which was obtained at a time corresponding to creation of a content item to stored voice models and to determine an identity of a speaker based on the comparison. The identity determining module is further configured to assign a tag to the content item based on the identity.

In another exemplary embodiment, a mobile terminal for utilizing speaker recognition in content management is provided. The mobile terminal includes an identity determining module. The identity determining module is configured to compare an audio sample which was obtained at a time corresponding to creation of a content item to stored voice models and to determine an identity of a speaker based on the comparison. The identity determining module is further configured to assign a tag to the content item based on the identity.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram showing an encoding module and a decoding module according to an exemplary embodiment of the present invention;

FIG. 4 is a screenshot of a display according to an exemplary embodiment of the present invention;

FIG. 5 is a screenshot of a display according to an exemplary embodiment of the present invention;

FIG. 6 is a screenshot of a display according to an exemplary embodiment of the present invention;

FIG. 7 is a screenshot of a display according to an exemplary embodiment of the present invention; and

FIG. 8 is a flowchart according to an exemplary method of utilizing speaker recognition in metadata-based content management according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

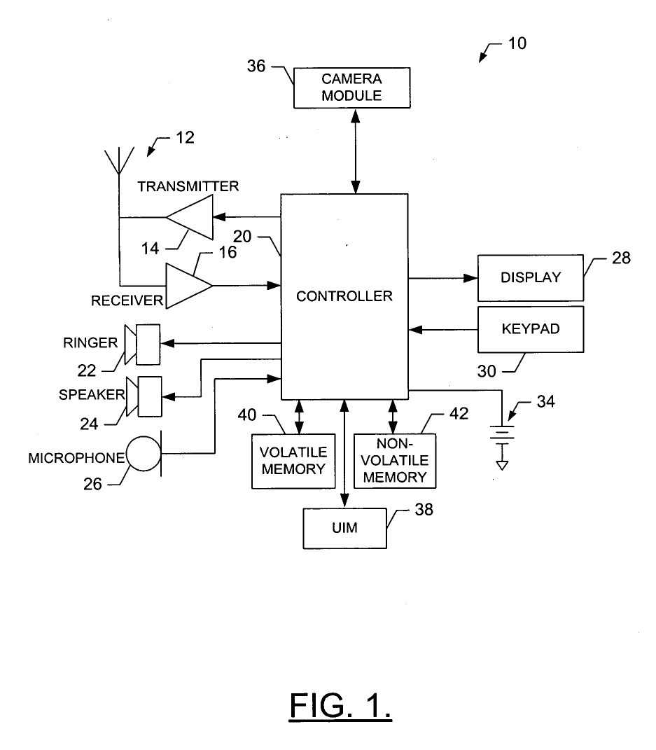

FIG. 1 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as digital cameras, digital camcorders, audio devices, portable digital assistants (PDAs), pagers, mobile televisions, laptop computers, GPS devices, wrist watches, and other types of voice and text communications systems in any combinations of the aforementioned, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing module 36, such as a camera, video and/or audio module, in communication with the controller 20. The media capturing module 36 may be any means for capturing an image, video and/or audio for storage, display or transmission. For example, in an exemplary embodiment in which the media capturing module 36 is a camera module, the camera module 36 may include a digital camera capable of forming a digital image file from a captured image. As such, the camera module 36 includes all hardware, such as a lens or other optical device, and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, California, or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

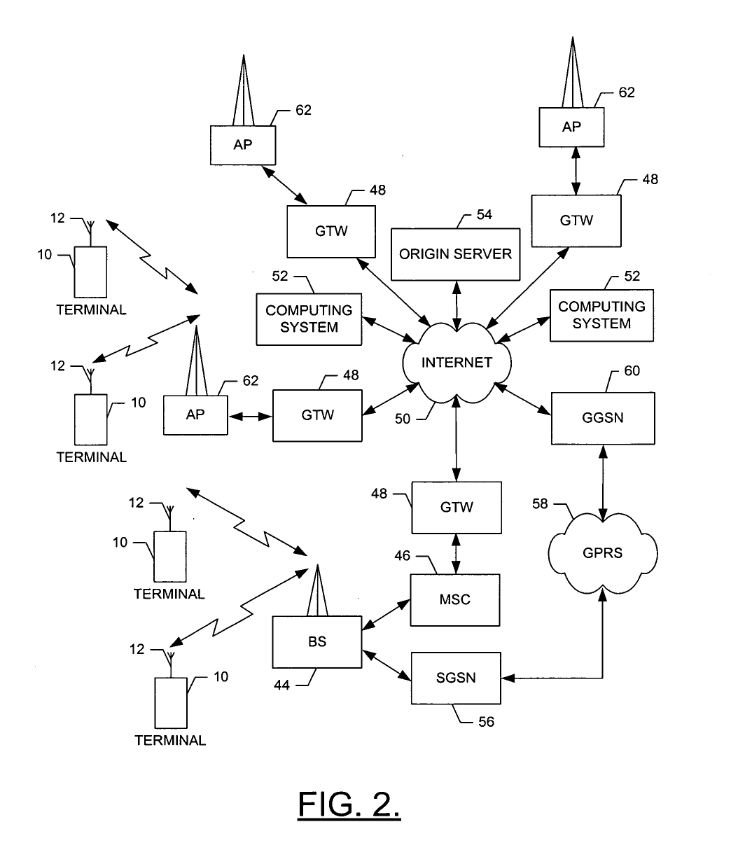

Referring now to FIG. 2, an illustration of one type of system that would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

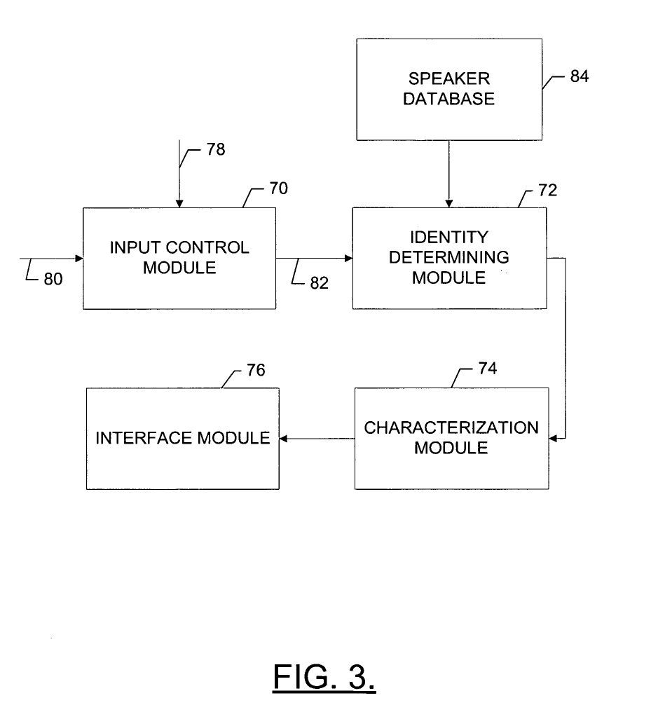

An exemplary embodiment of the invention will now be described with reference to FIG. 3, in which certain elements of a system for utilizing speaker recognition in metadata-based content management are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. For example, the system of FIG. 3 may be employed on a personal computer, a camera, a video recorder, a remote server, etc. It should also be noted, however, that while FIG. 3 illustrates one example of a configuration of a system for utilizing speaker recognition in metadata-based content management, numerous other configurations may also be used to implement the present invention.

Referring now to FIG. 3, a system for utilizing speaker recognition in metadata-based content management is provided. The system includes an input control module 70, an identity determining module 72, a characterization module 74, and an interface module 76. It should be noted that although the system of FIG. 3 includes the characterization module 74, the characterization module 74 may be an optional element. In such an embodiment, the interface module 76 may communicate directly with the identity determining module 72. It should also be noted that any or all of the input control module 70, the identity determining module 72, the characterization module 74, and the interface module 76 may be collocated in a single device. In an exemplary embodiment, the input control module 70, the identity determining module 72, the characterization module 74, and the interface module 76 may each be embodied in software instructions stored in a memory of the mobile terminal 10 and executed by the controller 20. It should also be noted that although the present invention will be described below primarily in the context of content items that are still images such as pictures or photographs, any content item that may be created at the mobile terminal 10 or any other device employing embodiments of the present invention is also envisioned.

The input control module 70 may be any device or means embodied in either hardware, software, or a combination of hardware and software that is capable of controlling when analysis of a speakers voice for utilization in speaker recognition will occur. In an exemplary embodiment, the input control module 70 is in operable communication with the camera module 36. In this regard, the input control module 70 may receive an indication 78 from the camera module 36 that a content item is about to be created. For example, the indication 78 may be indicative of an intention to create a content item, which may be inferred when a camera application is launched, when lens cover removal is detected, or any other suitable way. In an exemplary embodiment, the input control module receives input audio 80 from areas proximate to the mobile terminal 10 and may begin recording audio data from the input audio 80 when the camera application is launched. Thus, an audio sample including audio data may be recorded before, during and after an image is captured. The audio sample including either a portion of the recorded audio data or all of the recorded audio data may then be communicated to the identity determining module 72 for speaker recognition processing. In an exemplary embodiment, audio data may be recorded during the entire time that the camera application is active, however, only a portion of the recorded audio data corresponding to a predetermined time period after and/or before content item creation may be communicated to the identity determining module 72 as recognition data 82 associated with the content item created. In other words, for example, the input control module 70 may communicate audio data corresponding to a predetermined time before and/or after an image is created to the identity determining module 72 in response to creation of the image. It should be noted that the recognition data 82 may be recorded as described above, or communicated in real-time responsive to control by the input control module 70.

The identity determining module 72 may be any device or means embodied in either hardware, software, or a combination of hardware and software that is capable of determining an identity of a speaker based on the recognition data 82 including voice data from the speaker. The identity determining module 72 may also be capable of determining corresponding identities for a plurality of speakers given voice data from the plurality of speakers. In an exemplary embodiment, the identity determining module 72 receives the recognition data 82 and compares voice data included in the recognition data 82 to voice models that may be stored in the identity determining module 72 or in another location. The voice models may include models of voices of any number of previously recorded speakers. The voice models may be produced by any means known in the art, such as by recording and sampling the voice patterns of respective speakers. The voice models may be stored, for example, in a speaker database 84 which may be a part of the identity determining module 72 or located remote from the identity determining module 72. As such, the speaker database 84 may include a presentation of “long-term” statistical characteristics of speech for each speaker. The statistical characteristics may be gathered, for example, from phone conversations conducted with the speaker, or from previous recordings of the speaker conducted by the mobile terminal 10 or stored at the mobile terminal 10, a network server, a personal computer, a storage device, etc. Each of the voice models may correspond to a particular identity. For example, if a name of the speaker is known then the name may form the identity for the speaker. Alternatively, a label of “unknown” or any other appropriate or distinctive label may form the identity for a particular speaker.

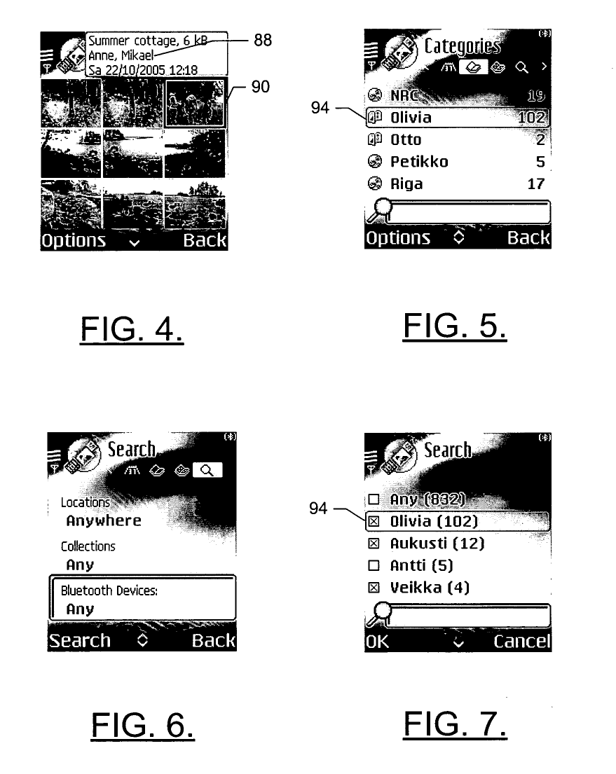

As stated above, the identity determining module 72 compares voice data from the recognition data 82 to the voice models in order to determine the identity of any speakers associated with the voice data. If one or more speakers in a particular segment of recognition data 82 cannot be identified, the user may be notified of the failure to recognize the speaker via the interface module 76. Additionally, the user may be given an option to assign a new identity for each of the one or more speakers that could not be identified. The assignment of the new identity may be performed manually, or in conjunction with any of the characterization mechanisms described below in conjunction with the characterization module 74. If one or more speakers in a particular segment of recognition data 82 can be correlated with a corresponding voice model, a metadata or other annotation 88 based on the identity associated with the corresponding voice model may be assigned to the content item associated with the recognition data 82. The interface module 76 may then display the metadata annotation 88 of the identity when a corresponding content item 90 is highlighted or selected, for example, on the display 28 of the mobile terminal 10 as shown in FIG. 4. The metadata annotation 88 may then be used for content management. For example, content items may be sorted or organized according to the metadata annotation 88. Alternatively, a search may be conducted for content items associated with the metadata annotation 88.

The interface module 76 may be any device or means embodied in either hardware, software, or a combination of hardware and software that is capable of presenting information associated with content items to the user, for example, on the display 28 of the mobile terminal 10. The information associated with the content items may include, for example, thumbnails of images corresponding to each content item and the metadata annotation 88 of a highlighted or selected content item as shown in FIG. 4. The interface module 76 may also provide the user with a list of automatically or manually created speaker categories in which each of the categories contains a group of content items associated with each identity or characterization as shown in FIG. 5. The list may include, for example, a category for “unknown” speakers and a category for content items for which the recognition data includes no speech or indiscernible speech. The list may be organized by identity or by a characterization associated with the identity as described below. Alternatively, the category for unknown speakers may present each different unknown speaker as a particular identity such as “unknown 1”, “unknown 2”, etc., or “speaker 1”, “speaker 2”, etc. As such, in a situation where a new speaker is initially identified as an unknown speaker, where a speaker is mistakenly identified as an unknown speaker or where an identity of a previously unknown speaker becomes known to the user, the user may be able to access the unknown category and manually label a particular unknown speaker with a respective correct identity.

The interface module 76 may also provide the user with a mechanism by which to select a specific speaker as search criteria. For example, data entry may be performed in a field as shown in FIG. 6, for specifying search criteria using the keypad 30. Alternatively, a menu item may be selected using a cursor, soft keys or other suitable methods to perform a search as shown in FIG. 7. In conducting a search, metadata annotations may be searched for metadata annotations that match the search criteria. As a result of such the search, content items associated with the search criteria (e.g. a selected speaker) may be displayed as thumbnails or otherwise presented for viewing or selection by the user.

The characterization module 74 may be any device or means embodied in either hardware, software, or a combination of hardware and software that is capable of assigning a characterization 96 to a particular speaker. The characterization 96 may be any user understandable identifier by which the particular speaker may be recognized by the user. For example, the characterization 96 may be a shortened version of the identity, a made up label, etc. Alternatively, the characterization 96 may be associated with an object that is already known to the mobile terminal 10, such as a phonebook entry or a known device. Some embodiments of characterization assignment will now be discussed for purposes of providing examples, and not by way of limitation. Thus, the present invention should not be considered to be limited to the examples disclosed herein.

One exemplary characterization assignment may be a manually performed. For example, a name corresponding to the identity, a nickname, a title, a label, or any other suitable identification mechanism may be manually assigned to correspond to a speaker. The user may manually assign the characterization 96 via the interface module 76. Such manual assignment could be performed, for example, by entering a textual characterization using the keypad 30 or another text entry device or by manually correlating the speaker to a phonebook entry. In order to make label selection easier, a short recording of the speaker's voice may be played before the manual labeling occurs.

Another exemplary characterization assignment may be automatically performed by the mobile terminal 10 or other device employing the present invention. For example, the speaker's voice may automatically be associated with an existing characterization of a corresponding phonebook entry. As such, during phone conversations, voices of both the user and the speaker may be recorded for voice modeling using the “long-term” statistical characteristics of the user and the speaker. Accordingly, a very good model can be achieved in this way. The characterization module 74 may then include a database or other correlation device to correlate a particular identity to an existing characterization of a corresponding phonebook entry. Thus, when the identity determining module 72 assigns an identity to a speaker that is recognized from a segment of recognition data 82, the characterization module 74 may automatically correlate the content item corresponding to the recognition data 82 with a phonebook entry corresponding to the identity of the speaker.

As another alternative, automatic characterization assignment may be performed by associating the speaker with nearby devices. For example, by simultaneously detecting a speaker and a nearby device on multiple occasions, a reasonably high probability may exist that the speaker correlates to the device. Accordingly, when a sufficiently high probability of correlation is reached, a speaker-to-device correlation may be made and an existing characterization for the device may be assigned to the identity of the speaker whenever the speaker's voice is detected. Furthermore, the device may be associated with a phonebook entry, thereby allowing the identity of the speaker, once determined, to be correlated to an existing characterization for the phonebook entry via correlation of the speaker to the device, and the device to the phonebook entry.

As yet another alternative, embodiments of the present invention may be used in conjunction with face recognition devices that may be employed on the mobile terminal 10 or any other device capable of practicing the present invention. As such, the face recognition device may have the capability to correlate a person in an image with a particular existing characterization. The existing characterization may have been developed in response to face models created from video calls which can be associated with a corresponding phonebook entry. Alternatively, the existing characterization may have been developed by manually assigning a textual characterization to a particular image or thumbnail of a face. Face recognition typically involves using statistical modeling to create relationships between a face in an image and a known face, for example, from another image. Statistical modeling may also be used to create relationships between recognized faces and speakers. Thus, for example, if a face is discernable in a particular image which forms a content item having associated recognition data 82, the characterization module 74 may include software capable of employing both face recognition and speaker recognition techniques to develop a statistical probability that the speaker and the face are related. Thus, a face-to-speaker relationship may be determined. The face-to-speaker relationship may then be used to associate a speaker with an existing characterization associated with the face. Furthermore, the face may be correlated with a phonebook entry, such that the speaker can be correlated to an existing characterization associated with the phonebook entry via face recognition.

As stated above, although the present invention was primarily described in the context of content items that are still images such as pictures or photographs, any content item that may be created at the mobile terminal 10 or any other device employing embodiments of the present invention is also envisioned. For example, in a situation where the content item is audio or video which includes audio content, the audio content in content items associated with either the audio or the video may be used as described above for assigning appropriate metadata or other tags to the content items based on the identity of the speaker as determined via the principles described above: In other words, when the content item is audio or video which includes audio material, there is no need to capture additional audio in order to employ embodiments of the present invention.

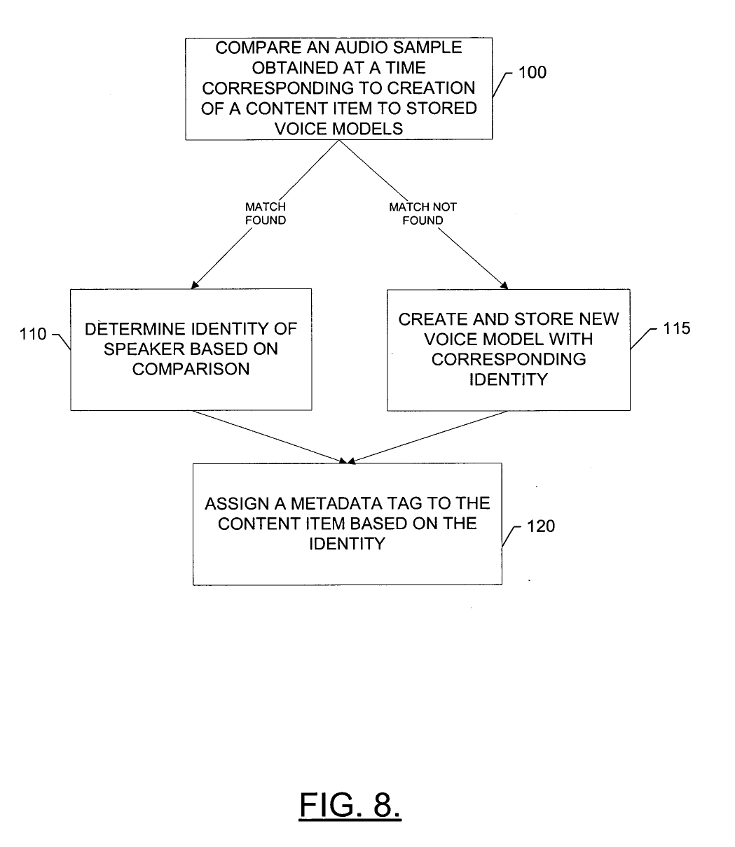

FIG. 8 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for utilizing speaker recognition in metadata-based content management includes comparing an audio sample obtained at a time corresponding to creation of a content item to stored voice models at operation 100. At operation 110, an identity of a speaker is determined based on the comparison. If the audio sample does not correspond to any of the stored voice models, then a new voice model is stored corresponding to the audio sample and a new identity may be assigned at operation 115. A quality check regarding recording quality of the audio sample may be performed to ensure the audio sample meets a quality standard before any identity can be assigned to the speaker. As such, the quality standard may be chosen to create a reasonably high probability that the speaker recorded in the audio sample can be accurately compared to the stored voice models. A metadata tag is assigned to the content item based on the identity at operation 120. The method may include an additional operation of manually or automatically correlating the identity to an existing phonebook entry, device, or face recognition characterization. The method may also include associating a plurality of content items in a group with a particular characterization in response to each of the content items of the group having a same metadata tag. In an exemplary embodiment, the method includes providing a user interface configured to enable searching for content items based on the particular characterization and/or enable presentation of a list of characterizations.

It should be noted once again that although the preceding exemplary embodiment has been described in the context of image related content items, embodiments of the present invention may also be practiced in the context of any other content item. Furthermore, embodiments of the present invention may be advantageously employed for utilization of speaker recognition for metadata-based content management in numerous types of devices such as, for example, a mobile terminal, a personal computer, a remote or local server, a video recorder, a network attached storage device, etc. It should also be noted that embodiments of the present invention need not be confined to application on a single device, as described in exemplary embodiments above. In other words, some operations of a method according to embodiments of the present invention may be performed on one device, while other operations are performed on a different device. Similarly, one or more of the modules described above may be embodied on a different device. For example, processing operations, such as those performed in the identity determining module 72, the characterization module 74 and/or the speaker database 84, may be performed on one device, such as a server, while display operations are performed on a different device, such as a mobile terminal. Additionally, stored voice models may be located at one device, while a comparison between the voice models and recognition data occurs on a separate device. Furthermore, audio samples may be recorded or processed in real time, as stated above. However, a device obtaining the audio samples may, in any case, be separate from a device that stores the audio samples, which may in turn be separate from a device which processes the audio samples.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of utilizing speaker recognition in content management, the method comprising:
comparing an audio sample which was obtained at a time corresponding to creation of a content item to stored voice models;
determining an identity of a speaker based on the comparison; and
assigning a tag to the content item based on the identity.

2. A method according to claim 1, further comprising manually correlating the identity to an existing characterization.

3. A method according to claim 1, further comprising automatically correlating the identity to an existing phonebook characterization.

4. A method according to claim 1, further comprising automatically correlating the identity to an existing device characterization.

5. A method according to claim 1, further comprising automatically correlating the identity to an existing face recognition characterization.

6. A method according to claim 1, further comprising associating a plurality of content items in a group with a particular characterization in response to each of the content items of the group having a same tag.

7. A method according to claim 6, further comprising providing a user interface configured to enable searching for content items based on the particular characterization.

8. A method according to claim 6, further comprising providing a user interface configured to enable presentation of a plurality of characterizations.

9. A method according to claim 1, wherein assigning the tag comprises assigning a metadata tag.

10. A computer program product for utilizing speaker recognition in content management, the computer program product comprising at least one computer-readable storage medium having computer-readable program code portions stored therein, the computer-readable program code portions comprising:
a first executable portion for comparing an audio sample which was obtained at a time corresponding to creation of a content item to stored voice models;
a second executable portion for determining an identity of a speaker based on the comparison; and
a third executable portion for assigning a tag to the content item based on the identity.

11. A computer program product according to claim 10, further comprising a fourth executable portion for manually correlating the identity to an existing characterization.

12. A computer program product according to claim 10, further comprising a fourth executable portion for automatically correlating the identity to one of an existing phonebook characterization, an existing device characterization, or an existing face recognition characterization.

13. A computer program product according to claim 10, further comprising a fourth executable portion for associating a plurality of content items in a group with a particular characterization in response to each of the content items of the group having a same tag.

14. A computer program product according to claim 13, further comprising a fifth executable portion for providing a user interface configured to enable searching for content items based on the particular characterization.

15. A computer program product according to claim 13, further comprising a fifth executable portion for providing a user interface configured to enable presentation of a plurality of characterizations.

16. An apparatus for utilizing speaker recognition in content management, the apparatus comprising:
an identity determining module configured to compare an audio sample which was obtained at a time corresponding to creation of a content item to stored voice models and to determine an identity of a speaker based on the comparison,
wherein the identity determining module is further configured to assign a tag to the content item based on the identity.

17. An apparatus according to claim 16, further comprising a characterization module in communication with the identity determining module.

18. An apparatus according to claim 17, wherein the characterization module is configured to manually correlate the identity to an existing characterization.

19. An apparatus according to claim 17, wherein the characterization module is configured to automatically correlate the identity to an existing phonebook characterization.

20. An apparatus according to claim 17, wherein the characterization module is configured to automatically correlate the identity to an existing device characterization.

21. An apparatus according to claim 17, wherein the characterization module is configured to automatically correlate the identity to an existing face recognition characterization.

22. An apparatus according to claim 17, wherein the characterization module is configured to associate a plurality of content items in a group with a particular characterization in response to each of the content items of the group having a same tag.

23. An apparatus according to claim 22, further comprising an interface module in communication with the identity determining module, the interface module being configured to provide a user interface configured to enable searching for content items based on the particular characterization.

24. An apparatus according to claim 22, further comprising an interface module in communication with the identity determining module, the interface module being configured to provide a user interface configured to enable presentation of a plurality of characterizations.

25. An apparatus according to claim 16, further comprising an input control module in communication with the identity determining module, wherein the input control module is configured to record the audio sample for a predetermined period of time proximate to the time corresponding to creation of the content item.

26. An apparatus according to claim 25, wherein the input control module is configured to record the audio sample in response to an indication of an intent to create the content item.

27. An apparatus according to claim 16, wherein the tag is a metadata tag.

28. A mobile terminal for utilizing speaker recognition in content management, the mobile terminal comprising:
an identity determining module configured to compare an audio sample which was obtained at a time corresponding to creation of a content item to stored voice models and to determine an identity of a speaker based on the comparison,
wherein the identity determining module is further configured to assign a tag to the content item based on the identity.

29. A mobile terminal according to claim 28, further comprising a characterization module in communication with the identity determining module.

30. A mobile terminal according to claim 29, wherein the characterization module is configured to manually correlate the identity to an existing characterization.

31. A mobile terminal according to claim 29, wherein the characterization module is configured to automatically correlate the identity to one of:
an existing phonebook characterization;
an existing device characterization; and
an existing face recognition characterization.

32. A mobile terminal according to claim 28, wherein the characterization module is configured to associate a plurality of content items in a group with a particular characterization in response to each of the content items of the group having a same tag.

33. A mobile terminal according to claim 32, further comprising an interface module in communication with the identity determining module, the interface module being configured to provide a user interface configured to enable searching for content items based on the particular characterization.

34. A mobile terminal according to claim 32, further comprising an interface module in communication with the identity determining module, the interface module being configured to provide a user interface configured to enable presentation of a plurality of characterizations.

35. A mobile terminal according to claim 28, further comprising an input control module in communication with the identity determining module, wherein the input control module is configured to record the audio sample for a predetermined period of time proximate to the time corresponding to creation of the content item.

36. A mobile terminal according to claim 35, wherein the input control module is configured to record the audio sample in response to an indication of an intent to create the content item.
